(19) United States
(12) Patent Application Publication
(10) Pub. No.: US 2008/0206651 A1
(43) Pub. Date: Aug. 28, 2008

(54) ANODE, METHOD OF MANUFACTURING IT, AND BATTERY

(75) Inventors: Kenichi Kawase, Fukushima (JP); Koichi Matsumoto, Fukushima (JP); Hideki Nakai, Fukushima (JP); Masayuki Iwama, Fukushima (JP); Akinori Kita, Fukushima (JP); Shunsuke Kurasawa, Fukushima (JP); Isamu Konishiike, Fukushima (JP); Takakazu Hirose, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation, Tokyo (JP)

(21) Appl. No.: 12/031,799

(22) Filed: Feb. 15, 2008

(30) Foreign Application Priority Data
Feb. 16, 2007 (JP) 2007-035795
Jul. 6, 2007 (JP) 2007-178366

(51) Int. Cl. H01M 6/16; H01M 4/48; H01M 4/52; H01M 4/04

(52) U.S. Cl. 429/330; 429/218.1; 429/221; 427/58

(57) ABSTRACT

A battery having a high charge and discharge efficiency is provided. An anode being provided with an anode active material layer on an anode current collector, in which the anode active material layer contains silicon as an anode active material and includes a compound film having Si—O bond and Si—N bond on at least part of the surface of the anode active material layer.

### CROSS REFERENCES TO RELATED APPLICATIONS

The present invention contains subject matter related to Japanese Patent Application JP 2007-035795 filed in the Japanese Patent Office on Feb. 16, 2007 and Japanese Patent Application JP 2007-178366 filed in the Japanese Patent Office on Jul. 6, 2007, the entire contents of which being incorporated herein by references.

### BACKGROUND OF THE INVENTION

1. Field of the Invention

The present invention relates to an anode that contains an anode active material containing silicon (Si) as an element, a method of manufacturing it, and a battery including such an anode.

2. Description of the Related Art

In recent years, many portable electronic devices such as a combination camera (video tape recorder), a digital still camera, a mobile phone, a personal digital assistance, and a notebook personal computer have been introduced, and down sizing and weight saving thereof have been made. Accordingly, as a power source for such electronic devices, light-weight secondary batteries capable of providing a high energy density have been developed. Specially, lithium ion secondary batteries in which a carbon material is used for the anode, a complex material of lithium (Li) and a transition metal is used for the cathode, and ester carbonate is used for the electrolytic solution provide a higher energy density compared to existing lead batteries and nickel cadmium batteries, and therefore the lithium ion secondary batteries have been practically used widely.

Further, in recent years, as performance of portable electronic devices has been improved, further improvement of the capacity has been demanded. It has been considered that as an anode active material, tin, silicon or the like is used instead of the carbon material (for example, refer to U.S. Pat. No. 4,950,566). The theoretical capacity of tin is 994 mAh/g and the theoretical capacity of silicon is 4199 mAh/g, which are significantly large compared to the theoretical capacity of graphite, 372 mAh/g, and therefore capacity improvement can be expected therewith.

However, a tin alloy or a silicon alloy inserting lithium has a high activity. Therefore, there have been disadvantages that the electrolytic solution is easily decomposed, and further lithium is inactivated. Therefore, when charge and discharge are repeated, the charge and discharge efficiency is lowered, and sufficient cycle characteristics may not be obtained.

Accordingly, it has been considered to form an inert layer on the surface of an anode active material. For example, it has been considered to form a silicon oxide coat on the surface of the anode active material (for example, refer to Japanese Unexamined Patent Application Publication Nos. 2004-171874 and 2004-319469).

### SUMMARY OF THE INVENTION

However, in the case that the silicon oxide coat is provided, when the thickness thereof is increased, the reactive resistance is increased and the cycle characteristics become insufficient. In the result, with the use of the method of forming the coat made of silicon oxide on the surface of a high active anode active material, sufficient cycle characteristics are hardly obtained, and thus more improvement has been aspired.

In view of the foregoing, in the invention, firstly, it is desirable to provide an anode that can improve the charge and discharge efficiency and that can be easily formed, and a battery using such an anode. In the invention, secondary, it is desirable to provide a method of manufacturing an anode to more easily form such an anode.

According to an embodiment of the invention, there is provided a first anode provided with an anode active material layer on an anode current collector, in which the anode active material layer contains silicon as an anode active material and includes a compound film having Si—O bond and Si—N bond on at least part of the surface of the anode active material layer.

According to an embodiment of the invention, there is provided a second anode provided with an anode active material layer on an anode current collector, in which the anode active material layer contains an anode active material particle made of an anode active material containing silicon and includes a compound film having Si—O bond and Si—N bond on at least part of the surface of the anode active material particle.

According to an embodiment of the invention, there is provided a first method of manufacturing an anode including steps of providing an anode active material layer having an anode active material containing silicon on an anode current collector; and forming a compound film having Si—O bond and Si—N bond on at least part of the surface of the anode active material layer by liquid-phase deposition method.

According to an embodiment of the invention, there is provided a second method of manufacturing an anode including steps of providing an anode active material layer containing an anode active material particle made of an anode active material containing silicon on an anode current collector; and forming a compound film having Si—O bond and Si—N bond on at least part of the surface of the anode active material particle by liquid-phase deposition method.

According to embodiments of the invention, there are provided a first battery and a second battery respectively including a cathode, an anode, and an electrolyte, in which the first anode or the second anode in the foregoing embodiments of the invention is used as the anode.

According to the first anode of the embodiment of the invention, the compound film having Si—O bond and Si—N bond is provided on at least part of the surface of the anode active material layer containing silicon provided on the anode current collector. Thus, the chemical stability of the anode can be improved. Accordingly, in the first battery of the embodiment of the invention using the first anode, the charge and discharge efficiency is improved.

According to the second anode of the embodiment of the invention, the compound film having Si—O bond and Si—N bond is provided on at least part of the surface of the anode active material particle containing silicon provided on the anode current collector. Thus, the chemical stability of the anode can be improved. Accordingly, in the second battery of the embodiment of the invention using the second anode, the charge and discharge efficiency is improved.

According to the first and the second methods of manufacturing an anode in the embodiments of the invention, the compound film having Si—O bond and Si—N bond is provided in at least part of the surface of the anode active material layer (or the anode active material particle) containing silicon by liquid-phase deposition method. Thus, compared to a case using vapor-phase deposition method, the compound film with the superior chemical stability can be more uniformly formed. Accordingly, in the battery using the anode manufactured as above, the charge and discharge efficiency is improved.

Other and further objects, features and advantages of the invention will appear more fully from the following description.

### BRIEF DESCRIPTION OF THE DRAWINGS

FIG. 1 is a cross section showing a structure of a first secondary battery in the invention;

FIG. 2 is a cross section showing an enlarged part of a spirally wound electrode body shown in FIG. 1;

FIG. 3 is cross section showing a structure of a second secondary battery according to the invention;

FIG. 4 is a cross section taken along line IV-IV of a spirally wound electrode body shown in FIG. 3;

FIG. 5 shows a cross section showing a structure of a third secondary battery in the invention;

FIG. 6 is a cross section taken along line VI-VI of the third secondary battery shown in FIG. 5;

FIG. 7 is a schematic cross section showing an enlarged part of an anode as a second embodiment in the first to the third secondary batteries of the invention;

FIG. 8 is a schematic cross section showing an enlarged part of an anode as a modification of the second embodiment in the first to the third secondary batteries of the invention;

FIG. 9 is a cross section showing a structure of a secondary battery fabricated in examples of the invention;

FIG. 10 is a characteristics diagram showing a relation between an iron content in an anode active material and a discharge capacity retention ratio in Examples 3-1 to 3-5 of the invention; and

FIG. 11 is a characteristics diagram showing a relation between a cobalt content in an anode active material and a discharge capacity retention ratio in Examples 4-1 to 4-4 of the invention.

### DETAILED DESCRIPTION OF THE PREFERRED EMBODIMENTS

Embodiments of the invention will be hereinafter described in detail with reference to the drawings.

### First Embodiment

### First Battery

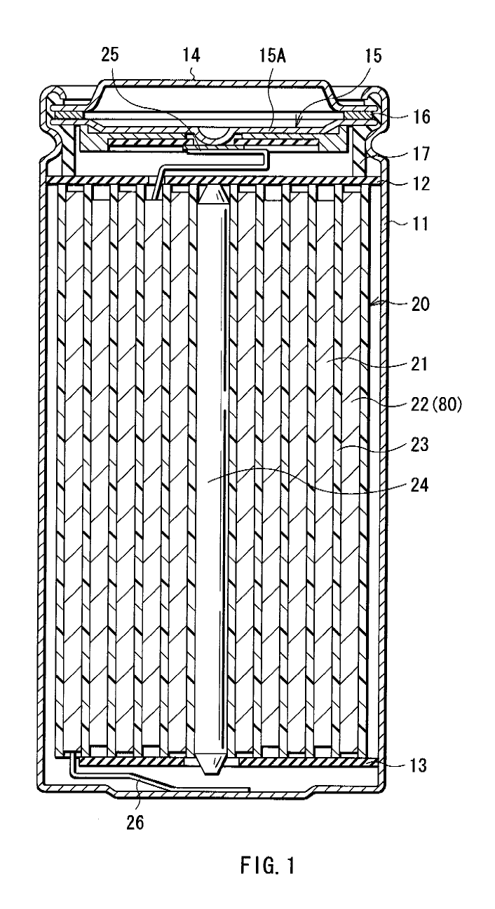

FIG. 1 shows a cross sectional structure of a first secondary battery as a first embodiment of the invention. The secondary battery is a so-called cylindrical battery, and has a spirally wound electrode body 20 in which a strip-shaped cathode 21 and a strip-shaped anode 22 are layered with a separator 23 in between and spirally wound inside a battery can 11 in the shape of an approximately hollow cylinder. The battery can 11 is made of, for example, iron plated by nickel. One end of the battery can 11 is closed, and the other end thereof is opened. Inside of the battery can 11, an electrolytic solution as a liquid electrolyte is injected therein and impregnated into a separator 23. A pair of insulating plates 12 and 13 is respectively arranged perpendicular to the spirally wound periphery face, so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is thereby hermetically sealed. The battery cover 14 is made of, for example, a material similar to that of the battery can 11. The safety valve mechanism 15 is electrically connected to the battery cover 14 through the PTC device 16. If the internal pressure of the battery becomes a certain level or more by internal short circuit, external heating or the like, a disk plate 15A flips to cut the electrical connection between the battery cover 14 and the spirally wound electrode body 20. If temperature rises, the PTC device 16 limits a current by increasing the resistance value to prevent abnormal heat generation by a large current due to external short circuit or the like. The gasket 17 is made of, for example, an insulating material and its surface is coated with asphalt.

For example, a center pin 24 is inserted in the center of the spirally wound electrode body 20. A cathode lead 25 made of aluminum (Al) or the like is connected to the cathode 21 of the spirally wound electrode body 20. An anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

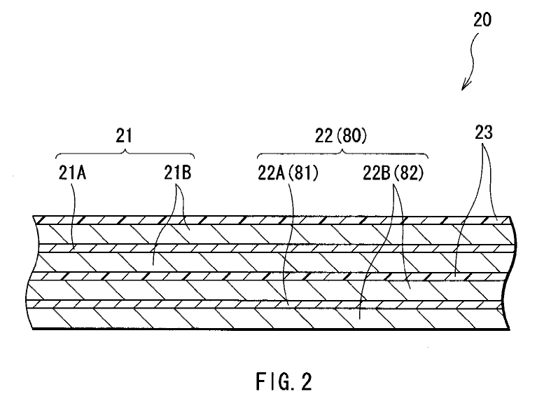

FIG. 2 shows an enlarged part of the spirally wound electrode body 20 shown in FIG. 1. The cathode 21 has, for example, a structure in which a cathode active material layer 21B is provided on the both faces of a cathode current collector 21A having a pair of opposed faces. The cathode current collector 21A is, for example, made of a metal foil such as an aluminum foil, a nickel foil, and a stainless foil.

The cathode active material layer 21B contains, for example, as a cathode active material, one or more cathode materials capable of inserting and extracting lithium. If necessary, the cathode active material layer 21B may contain an electrical conductor such as a carbon material and a binder such as polyvinylidene fluoride. As the cathode material capable of inserting and extracting lithium, for example, a chalcogenide not containing lithium such as titanium sulfide (TiS₂), molybdenum sulfide (MoS₂), niobium selenide (NbSe₂), and vanadium oxide (V₂O₅) can be cited. Further, a lithium-containing compound that contains lithium can be cited.

Specially, the lithium-containing compound is preferably used, since a high voltage and a high energy density can be thereby obtained. Such a lithium-containing compound includes, for example, a complex oxide containing lithium and a transition metal element and a phosphate compound containing lithium and a transition metal element. In particular, a compound containing at least one of cobalt, nickel, manganese, and iron is preferable, since a higher voltage can be thereby obtained. The chemical formula thereof can be expressed as, for example, LiₓMO₂ or Li_{y}MIIPO₄. In the formula, MI and MII represent one or more transition metal elements. Values of x and y vary according to charge and discharge states of the battery, and are generally in the range of 0.05≦x≦1.10 and 0.05≦y≦1.10.

As a specific example of such a complex oxide containing lithium and a transition metal element, a lithium cobalt complex oxide (LiₓCoO₂), a lithium nickel complex oxide (LiₓNiO₂), a lithium nickel cobalt complex oxide (LiₓN_{1-z}Co_{z}O₂ (z<1)), a lithium nickel cobalt manganese complex oxide (LiₓNi_{(1-v-W)}CoᵥMn_{w}O₂ (v+w<1)), or a lithium manganese complex oxide having a spinel structure (LiMn₂O₄) or the like can be cited. Specially, the complex oxide containing nickel is preferable, since a high capacity and superior cycle characteristics can be thereby obtained. Specific examples of the phosphate compound containing lithium and a transition metal element include, for example, lithium iron phosphate compound (LiFePO₄) and a lithium iron manganese phosphate compound (LiFe₁₋ᵤMnᵤPO₄ (u<1)).

The anode 22 has a structure in which, for example, an anode active material layer 22B is provided on the both faces of an anode current collector 22A as the cathode 21 does. The anode current collector 22A is made of a metal foil with the superior electrochemical stability, the superior electric conductivity, and the superior mechanical strength such as a copper foil, a nickel foil, and a stainless foil. Specially, copper is particularly preferable, since copper shows more superior electric conductivity, and is easily alloyed with silicon contained in the anode active material layer 22B as described below. When the anode current collector 22A and the anode active material layer 22B are alloyed, the contact characteristics thereof are improved, and thereby separation thereof hardly occurs. In addition, nickel, iron and the like are suitable as a component material of the anode current collector 22A, since they are easily alloyed with silicon.

The anode current collector 22A may have a single layer structure or a multilayer structure. When the anode current collector 22A has a multilayer structure, for example, the layer adjacent to the anode active material layer 22B may be made of a metal layer that is alloyed with the anode active material layer 22B, and layers not adjacent to the anode active material layer 22B may be made of other metal material.

The surface of the anode current collector 22A is preferably roughened (has irregularities). Thereby, due to the so-called anchor effect, the contact characteristics between the anode current collector 22A and the anode active material layer 22B are improved. In this case, it is enough that at least the face of the region of the anode current collector 22A that contacts with the anode active material layer 22B is roughened. As a roughening method, for example, a method of forming minute particles on the surface of the anode current collector 22A to provide irregularities by electrolytic processing can be cited. When the surface of the anode current collector 22A is roughened, the surface roughness Ra value is preferably, for example, from 0.1 μm to 0.5 μm. Thereby, the contact characteristics between the anode current collector 22A and the anode active material layer 22B are sufficiently improved.

The anode active material layer 22B contains an anode active material containing silicon as an element. Silicon has the high ability to insert and extract lithium, and thereby provides a high energy density.

Examples of the anode active material containing silicon include, for example, the simple substance, an alloy, or a compound of silicon; or a material having one or more phases thereof at least in part. In the invention, alloys also include an alloy containing one or more metal elements and one or more metalloid elements, in addition to an alloy including two or more metal elements. The alloy may contain a nonmetallic element. The texture thereof may be a solid solution, a eutectic crystal (eutectic mixture), an intermetallic compound, or a texture in which two or more of the foregoing textures coexist.

As the alloy of silicon, for example, an alloy containing at least one selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), arsenic (As), magnesium (Mg), calcium (Ca), aluminum (Al), and chromium (Cr) as a second element other than silicon can be cited. In particular, by adding an appropriate amount of iron, cobalt, nickel, germanium, tin, arsenic, zinc, copper, titanium, chromium, magnesium, calcium, aluminum, or silver as a second element to the anode active material, it is expected that the energy density is more improved compared to an anode active material made of the simple substance of silicon. If the second element that is possibly capable of improving the energy density is contained in the anode active material at the ratio of, for example, from 1.0 atomic % (at %) to 40 atomic % of the anode active material, it is evident that such a second element contributes to improve the discharge capacity retention ratio as a battery.

As the compound of silicon, for example, a compound containing oxygen (O) and carbon (C) can be cited. The compound of silicon may contain the foregoing second element.

The anode active material can be formed by, for example, mixing raw materials of the respective elements, melting the resultant mixture in an electric furnace, a high frequency inducing furnace, an arc melting furnace or the like, and then solidifying the resultant matter. Otherwise, the anode active material can be formed by, for example, various atomization methods such as gas atomization method and water atomization method, various rolling methods, or a method utilizing mechanochemical reaction such as mechanical alloying method and mechanical milling method. Specially, the anode active material is preferably formed by the method utilizing mechanochemical reaction, since the anode active material can thereby obtain a low crystallinity structure or an amorphous structure. For such a method, for example, a forming device such as a planetary ball mill device and an attritor can be used.

The anode active material layer 22B may further contain other anode active material or other material such as an electrical conductor in addition to the foregoing anode active material. As other anode active material, for example, a carbonaceous material capable of inserting and extracting lithium can be cited. The carbonaceous material is preferable, since the carbonaceous material can improve the charge and discharge cycle characteristics, and functions as an electrical conductor. As the carbonaceous material, for example, one or more of non-graphitizable carbon, graphitizable carbon, graphite, pyrolytic carbons, coke, glassy carbons, an organic polymer compound fired body, activated carbon, and carbon black can be used. Of the foregoing, the coke includes pitch coke, needle coke, petroleum coke and the like. The organic polymer compound fired body is a carbonized body obtained by firing a polymer compound such as a phenol resin and a furan resin at an appropriate temperature. The shape of these carbonaceous materials may be fibrous, spherical, granular, or scale-like.

On the surface of the anode active material layer 22B, a compound film having Si—O bond and Si—N bond is provided. Thereby, the chemical stability of the anode 22 is improved and the decomposition of the electrolytic solution is prevented, and thus the charge and discharge efficiency can be improved. It is enough that the compound film covers at least part of the surface of the anode active material layer 22B. However, to sufficiently improve the chemical stability, the compound film desirably covers a wide range of the surface of the anode active material layer 22B as much as possible.

The thickness of the compound film is preferably, for example, from 10 nm to 1000 nm. If the thickness is 10 nm or more, the compound film sufficiently covers the anode active material layer 22B, and thereby the decomposition of the electrolytic solution can be effectively prevented. If the thickness is 1000 nm or less, the resistance is prevented from being increased, and the energy density can be prevented from being lowered.

As a measurement method for examining bonding state of elements, for example, X-ray Photoelectron Spectroscopy (XPS) can be cited. In the XPS, in the apparatus in which energy calibration is made so that the peak of 4f orbit of gold atom (Au4f) is obtained at 84.0 eV, respective peaks of 2p orbit of silicon bonded to oxygen (Si2p_{1/2}Si—O and Si2p_{3/2}Si—O) are observed at 104.0 eV (Si2p_{1/2}Si—O) and 103.4 eV (Si2p_{3/2}Si—O). Meanwhile, respective peaks of 2p orbit of silicon bonded to nitrogen (Si2p_{1/2}Si—N and Si2p_{3/2}Si—N) are respectively observed in the region lower than that of the 2p orbit of silicon bonded to oxygen (Si2p_{1/2}Si—O and Si2p_{3/2}Si—O).

The separator 23 separates the anode 22 from the cathode 21, prevents current short circuit due to contact of the both electrodes, and lets through lithium ions. The separator 23 is made of, for example, a synthetic resin porous film composed of polytetrafluoroethylene, polypropylene, polyethylene or the like, or a ceramics porous film. The separator 23 may have a structure in which two or more of the foregoing porous films are layered.

An electrolytic solution impregnated in the separator 23 contains a solvent and an electrolyte salt dissolved in the solvent.

As a solvent, for example, carbonates, esters, ethers, lactones, nitriles, amides, or sulfones can be cited. Specifically, a nonaqueous solvent such as ethylene carbonate, propylene carbonate, butylene carbonate, vinylene carbonate, γ-butyrolactone, γ-valerolactone, diethyl carbonate, dimethyl carbonate, ethyl methyl carbonate, 1,2-dimethoxyethane, tetrahydrofuran, 2-methyltetrahydrofuran, 1,3-dioxolane, 4-methyl-1,3-dioxolane, ester acetate, ester butylate, ester propionate, acetonitrile, glutaronitrile, adiponitrile, and methoxyacetonitrile can be cited. For the solvent, one thereof may be used singly, or two or more thereof may be used by mixing.

The solvent preferably further contains fluorinated ester carbonate. Thereby, a favorable oxide-containing film can be formed on the surface of the electrode, and the decomposition reaction of the electrolytic solution can be further prevented. As such fluorinated ester carbonate, 4-fluoro-1,3-dioxolane-2-one, 4,5-difluoro-1,3-dioxolane-2-one, fluoromethylmethyl carbonate, bis(fluoromethyl)carbonate, or difluoromethylmethyl carbonate is preferable, since thereby higher effects can be obtained. One of the fluorinated ester carbonates may be used singly, or one or more thereof may be used by mixing.

As an electrolyte salt, for example, a lithium salt such as lithium hexafluorophosphate (LiPF₆), lithium tetrafluoroborate (LiBF₄), lithium hexafluoroarsenate (LiAsF₆), lithium perchlorate (LiClO₄), lithium trifluoromethanesulfonate (LiCF₃SO₃), lithium bis[trifluoromethanesulfonyl]imide ((CF₃SO₂)₂NLi), lithium tris (trifluoromethanesulfonyl)methyl ((CF₃SO₂)₃CLi), lithium trispentafluoroethyltrifluoro phosphate (LiP(C₂F₅)₃F₃), lithium trifluoromethyltrifluoro borate (LiB(CF₃)F₃), lithium pentafluoroethyltrifluoro borate (LiB(C₂F₅)F₃), lithium bis[pentafluoroethanesulfonyl]imide ((C₂F₅SO₂)₂NLi), lithium cyclol,3-perfluoropropanedisulfonyl imide, lithium bis[oxalate-O,O′]borate, and lithium difluoro[oxalate-O,O′]borate can be cited. One of the electrolyte salts may be used singly, or two or more thereof may be used by mixing.

The secondary battery can be manufactured, for example, as follows.

First, for example, a cathode active material, an electrical conductor, and a binder are mixed to prepare a cathode mixture, which is dispersed in a solvent such as N-methyl-2-pyrrolidone to obtain paste cathode mixture slurry. Subsequently, the cathode current collector 21A is coated with the cathode mixture slurry, which is dried and compression-molded by a rolling press machine or the like, and then the cathode active material layer 21B and the cathode 21 are formed.

Meanwhile, the anode 22 is formed as follows. First, an anode active material containing silicon as an element, an electrical conductor, and a binder are mixed to prepare an anode mixture, which is dispersed in a solvent such as N-methyl-2-pyrrolidone to obtain paste anode mixture slurry. Next, the anode current collector 22A is coated with the anode mixture slurry, which is dried and compression-molded, and then the anode active material layer 22B is formed. Subsequently, the compound film having Si—O bond and Si—N bond is formed by liquid-phase deposition method so that the compound film covers at least part of the surface of the anode active material layer 22B, and thereby the anode 22 was formed. The compound film is formed by reacting the anode active material to a solution containing a silazane compound. Si—O bond is generated by reacting a certain silazane compound to moisture in the atmosphere or the like. Meanwhile, Si—N bond is formed by reacting silicon composing the anode active material layer 22B to the silazane compound. Otherwise, Si—N bond can be generated by reacting a certain silazane compound to moisture in the atmosphere. As the silazane compound, for example, perhydropolysilazane (PHPS) can be used. Perhydropolysilazane is an inorganic polymer with the fundamental unit of —(SiH₂NH)—, and can be dissolved in an organic solvent.

After that, the cathode lead 25 is attached to the cathode current collector 21A by welding or the like, and the anode lead 26 is attached to the anode current collector 22A by welding or the like. Subsequently, the cathode 21 and the anode 22 are spirally wound with the separator 23 in between. The end of the cathode lead 25 is welded to the safety valve mechanism 15, and the end of the anode lead 26 is welded to the battery can 11. The spirally wound cathode 21 and the spirally wound anode 22 are sandwiched between the pair of insulating plates 12 and 13, and contained in the battery can 11. After the cathode 21 and the anode 22 are contained in the battery can 11, the electrolytic solution is injected into the battery can 11 and impregnated in the separator 23. After that, at the open end of the battery can 11, the battery cover 14, the safety valve mechanism 15, and the PTC device 16 are fixed by being caulked with the gasket 17. The secondary battery shown in FIGS. 1 and 2 is thereby fabricated.

In the secondary battery, when charged, for example, lithium ions are extracted from the cathode 21 and inserted in the anode 22 through the electrolytic solution. When discharged, for example, lithium ions are extracted from the anode 22, and inserted in the cathode 21 through the electrolytic solution. Since the compound film having Si—O bond and Si—N bond is provided on the surface of the anode active material layer 22B contacting with the electrolytic solution, the chemical stability is high.

As described above, in this embodiment, since the compound film having Si—O bond and Si—N bond is provided on at least part of the surface of the anode active material layer 22B containing silicon provided on the anode current collector 21A, the chemical stability of the anode 22 can be improved. Therefore, the decomposition reaction of the electrolytic solution is prevented, and thus the charge and discharge efficiency can be improved. In particular, since the compound film having Si—O bond and Si—N bond is formed by liquid-phase deposition method, the surface of the anode active material layer 22B contacting with the electrolytic solution can be covered with the more homogeneous compound film compared to a case using vapor-phase deposition method, and thus the chemical stability of the anode 22 can be more improved.

As mentioned before, the technique for forming the compound film made of SiO₂ on the surface of an anode active material has been already developed. However, in that case, it is difficult to form the compound film so that the film thickness is secured to the degree that favorable battery reaction is made. In addition, in particular, in the case where the compound film made of SiO₂ is formed by liquid-phase deposition method, there is the following shortcoming. In that case, in general, an acidic solution is used. Thus, a metal or a metalloid other than silicon that is added to the anode active material as a second element is eluted into the acidic solution. In the result, it is hard to obtain the multiple effects between the characteristics improvement by the surface coat and the characteristics improvement by the active material composition. Meanwhile, according to this embodiment, with the use of the easy manufacturing method, the surface of the anode active material layer 22B can be covered with the compound film that is more homogenized and that has the film thickness to the degree that the decomposition reaction of the electrolytic solution is sufficiently prevented and the favorable battery reaction is made. Therefore, deterioration of the cycle characteristics can be avoided. In addition, even when the second element is added to the anode active material, the abundance thereof is not decreased by forming the compound film. Therefore, when the second element has the characteristics contributing to improving the energy density, such characteristics can be fully reflected on improving the cycle characteristics as a battery.

### Second Battery

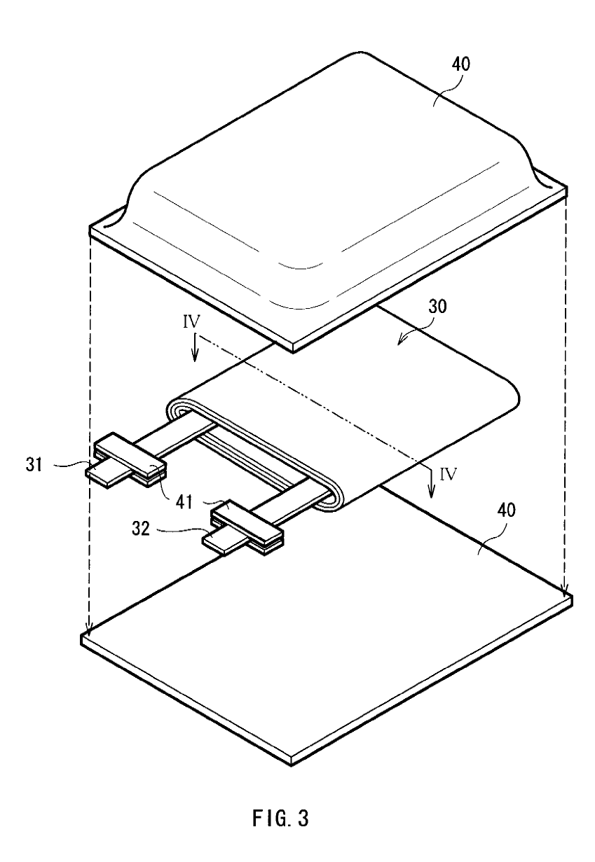

FIG. 3 shows a structure of a second secondary battery. The secondary battery is a so-called laminated film battery. In the secondary battery, a spirally wound electrode body 30 on which a cathode lead 31 and an anode lead 32 are attached is contained in a film package member 40.

The cathode lead 31 and the anode lead 32 are respectively directed from inside to outside of the package member 40 in the same direction, for example. The cathode lead 31 and the anode lead 32 are respectively made of, for example, a metal material such as aluminum, copper, nickel, and stainless, and are in the shape of a thin plate or mesh.

The package member 40 is made of a rectangular aluminum laminated film in which, for example, a nylon film, an aluminum foil, and a polyethylene film are bonded together in this order. The package member 40 is, for example, arranged so that the polyethylene film side and the spirally wound electrode body 30 are opposed, and the respective outer edges are contacted to each other by fusion bonding or an adhesive. Adhesive films 41 to protect from entering of outside air are inserted between the package member 40 and the cathode lead 31, the anode lead 32. The adhesive film 41 is made of a material having contact characteristics to the cathode lead 31 and the anode lead 32 such as a polyolefin resin of polyethylene, polypropylene, modified polyethylene, and modified polypropylene.

The package member 40 may be made of a laminated film having other structure, a polymer film such as polypropylene, or a metal film, instead of the foregoing aluminum laminated film.

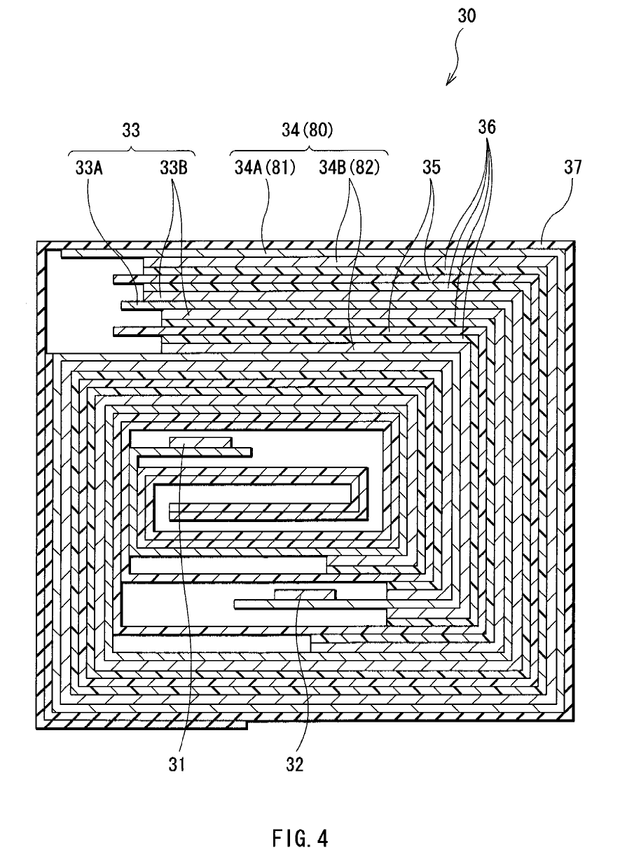

FIG. 4 shows a cross sectional structure taken along line IV-IV of the spirally wound electrode body 30 shown in FIG. 3. In the spirally wound electrode body 30, a cathode 33 and an anode 34 are layered with a separator 35 and an electrolyte layer 36 in between and spirally wound. The outermost periphery thereof is protected by a protective tape 37.

The cathode 33 has a structure in which a cathode active material layer 33B is provided on the both faces of a cathode current collector 33A. The anode 34 has a structure in which an anode active material layer 34B is provided on the both faces of an anode current collector 34A. Arrangement is made so that the anode active material layer 34B is opposed to the cathode active material layer 33B. Structures of the cathode current collector 33A, the cathode active material layer 33B, the anode current collector 34A, the anode active material layer 34B, and the separator 35 are similar to those of the cathode current collector 21A, the cathode active material layer 21B, the anode current collector 22A, the anode active material layer 22B, and the separator 23 in the first secondary battery shown in FIG. 1 and FIG. 2. The surface of the anode active material layer 34B is provided with the compound film having Si—O bond and Si—N bond.

The electrolyte layer 36 is gelatinous, containing an electrolytic solution and a polymer compound to become a holding body that holds the electrolytic solution. The gel electrolyte is preferable, since high ion conductivity can be thereby obtained and liquid leakage of the battery can be thereby prevented. The composition of the electrolytic solution is similar to that of the first embodiment. As the polymer compound, for example, an ether polymer compound such as polyethylene oxide and a crosslinking body containing polyethylene oxide, an ester polymer compound or an acrylate polymer compound such as polymethacrylate, or a polymer of vinylidene fluoride such as polyvinylidene fluoride and a copolymer of vinylidene fluoride and hexafluoropropylene can be cited. One thereof is used singly, or two or more thereof are used by mixing. In particular, in terms of redox stability, the fluorinated polymer compound such as the polymer of vinylidene fluoride is desirably used.

The secondary battery can be manufactured, for example, as follows.

First, the cathode 33 and the anode 34 are respectively coated with a precursor solution containing an electrolytic solution, a polymer compound, and a mixed solvent. The mixed solvent is volatilized to form the electrolyte layer 36. Next, the cathode lead 31 is attached to the cathode current collector 33A, and the anode lead 32 is attached to the anode current collector 34A. Subsequently, the cathode 33 and the anode 34 formed with the electrolyte layer 36 are layered with the separator 35 in between to obtain a lamination. After that, the lamination is spirally wound in the longitudinal direction, the protective tape 37 is adhered to the outermost periphery thereof to form the spirally wound electrode body 30. After that, for example, the spirally wound electrode body 30 is sandwiched between the package members 40, and outer edges of the package members 40 are contacted by thermal fusion bonding or the like to enclose the spirally wound electrode body 30. The adhesive films 41 are inserted between the cathode lead 31, the anode lead 32 and the package member 40. Thereby, the secondary battery shown in FIGS. 3 and 4 is fabricated.

Further, the secondary battery may be fabricated as follows. First, as described above, the cathode 33 and the anode 34 are formed, and the cathode lead 31 and the anode lead 32 are attached on the cathode 33 and the anode 34. After that, the cathode 33 and the anode 34 are layered with the separator 35 in between and spirally wound. The protective tape 37 is adhered to the outermost periphery thereof, and a spirally wound body as a precursor of the spirally wound electrode body 30 is formed. Next, the spirally wound body is sandwiched between the package members 40, the outermost peripheries except for one side are thermally fusion-bonded to obtain a pouched state, and the spirally wound body is contained in the package member 40. Subsequently, a composition of matter for electrolyte containing an electrolytic solution, a monomer as a raw material for the polymer compound, and if necessary other material such as a polymerization initiator and a polymerization inhibitor is prepared, which is injected into the package member 40. After that, the opening of the package member 40 is thermally fusion-bonded and hermetically sealed. After that, the resultant is heated to polymerize the monomer to obtain a polymer compound. Thereby, the gel electrolyte layer 36 is formed, and the secondary battery shown in FIGS. 3 and 4 is assembled.

The second secondary battery works in the same manner as the first secondary battery in this embodiment does, and can provide effects similar to those of the first secondary batteries.

### Third Battery

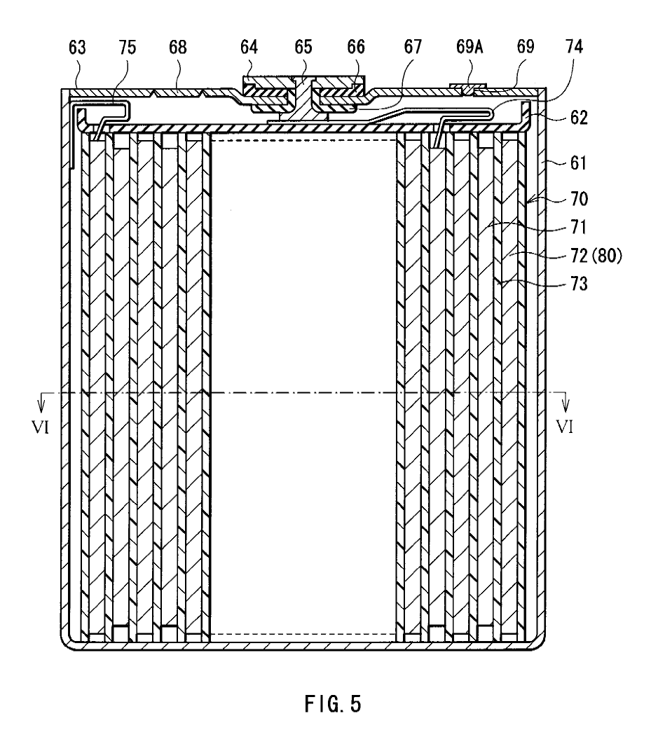

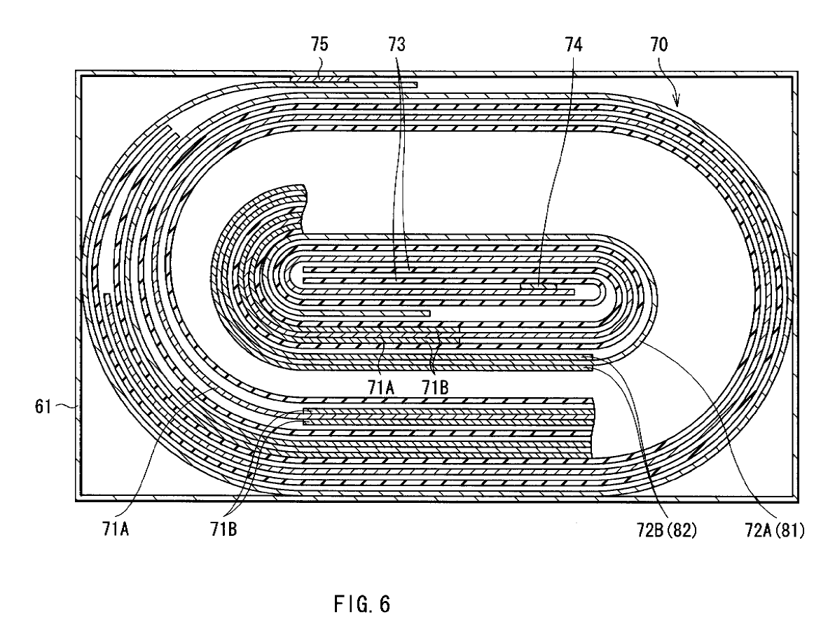

FIG. 5 and FIG. 6 show a cross sectional structure of a third secondary battery in this embodiment. FIG. 6 corresponds to a cross section taken along line VI-VI shown in FIG. 5. The battery is a so-called square battery. The battery contains a spirally wound electrode body 70 having a flat spirally wound structure inside a square battery can 61 in the shape of an approximate cuboid.

The square battery can 61 has the shape in which the cross section in the longitudinal direction is a rectangle or an approximate rectangle including curved lines in part.

The battery can 61 is made of, for example, a metal material containing iron, aluminum (Al), or an alloy thereof. The battery can 61 also has a function as an anode terminal. In this case, to prevent the secondary battery from being swollen by using the rigidity (hardly deformable characteristics) of the battery can 61 when charged and discharged, the battery can 61 is preferably made of rigid iron than aluminum. When the battery can 61 is made of iron, for example, the iron may be plated by nickel (Ni) or the like.

The battery can 61 has a hollow structure in which one end of the battery can 61 is closed and the other end thereof is opened. At the open end of the battery can 61, an insulating plate 62 and a battery cover 63 are attached, and thereby inside of the battery can 61 is hermetically closed. The insulating plate 62 is located between the spirally wound electrode body 70 and the battery cover 63, is arranged perpendicular to the spirally wound circumferential face of the spirally wound electrode body 70, and is made of, for example, polypropylene or the like. The battery cover 63 is, for example, made of a material similar to that of the battery can 61, and also has a function as an anode terminal.

Outside of the battery cover 63, a terminal plate 64 as a cathode terminal is provided. The terminal plate 64 is electrically insulated from the battery cover 63 with an insulating case 66 in between. The insulating case 66 is made of, for example, polybutylene terephthalate or the like. In the approximate center of the battery cover 63, a through-hole is provided. A cathode pin 65 is inserted in the through-hole so that the cathode pin is electrically connected to the terminal plate 64 and is electrically insulated from the battery cover 63 with a gasket 67 in between. The gasket 67 is made of, for example, an insulating material and its surface is coated with asphalt.

In the vicinity of the rim of the battery cover 63, a cleavage valve 68 and an injection hole 69 are provided. The cleavage valve 68 is electrically connected to the battery cover 63. If the internal pressure of the battery becomes a certain level or more due to internal short circuit, external heating or the like, the cleavage valve 68 is departed from the battery cover 63 to release the internal pressure. The injection hole 69 is sealed by a sealing member 69A made of, for example, a stainless steel ball.

In the spirally wound electrode body 70, a cathode 71 and an anode 72 are layered with a separator 73 in between, and are spirally wound. The spirally wound electrode body 70 is flat according to the shape of the battery can 61. A cathode lead 74 made of aluminum or the like is attached to an end of the cathode 71 (for example, the internal end thereof). An anode lead 75 made of nickel or the like is attached to an end of the anode 72 (for example, the outer end thereof). The cathode lead 74 is electrically connected to the terminal plate 64 by being welded to an end of the cathode pin 65. The anode lead 75 is welded and electrically connected to the battery can 61.

In the cathode 71, for example, a cathode active material layer 71B is provided on the both faces of a strip-shaped cathode current collector 71A. In the anode 72, an anode active material layer 72B is provided on the both faces of a strip-shaped anode current collector 72A. The cathode 71 and the anode 72 are arranged so that the cathode active material layer 71B is opposed to the anode active material layer 72B with the separator 73 in between. The structures of the cathode current collector 71A, the cathode active material layer 71B, the anode current collector 72A, the anode active material layer 72B, and the separator 73 are respectively similar to the structures of the cathode current collector 21A, the cathode active material layer 21B, the anode current collector 22A, the anode active material layer 22B, and the separator 23 in the first secondary battery shown in FIG. 1 and FIG. 2. The compound film having Si—O bond and Si—N bond is provided on the surface of the anode active material layer 72B.

An electrolytic solution as a liquid electrolyte is impregnated in the separator 73. The composition of the electrolytic solution is similar to that of the electrolytic solution of the foregoing first secondary battery (FIG. 1 and FIG. 2).

The secondary battery is manufactured, for example, by the following procedure.

First, the cathode 71 and the anode 72 are formed in the same manner as that of the cathode 21 and the anode 22 of the foregoing first secondary battery.

Next, the spirally wound electrode body 70 is formed. That is, the cathode lead 74 and the anode lead 75 are respectively attached to the cathode current collector 71A and the anode current collector 72A by welding or the like. After that, the cathode 71 and the anode 72 are layered with the separator 73 in between, and spirally wound in the longitudinal direction. Finally, the resultant is formed in the flat shape, and thereby the spirally wound electrode body 70 is obtained.

After the spirally wound electrode body 70 is contained in the battery can 61, the insulating plate 62 is arranged on the spirally wound electrode body 70. Subsequently, the cathode lead 74 and the anode lead 75 are respectively connected to the cathode pin 65 and the battery can 61 by welding or the like. After that, the battery cover 63 is fixed on the open end of the battery can 61 by laser welding or the like. Finally, the electrolytic solution is injected into the battery can 61 from the injection hole 69, and impregnated in the separator 73. After that, the injection hole 69 is sealed by the sealing member 69A. The secondary battery shown in FIG. 5 and FIG. 6 is thereby fabricated.

The third secondary battery works in the same manner as the first secondary battery in this embodiment does, and can provide effects similar to those of the first secondary battery.

### Second Embodiment

A description will be hereinafter given of a secondary battery as a second embodiment of the invention.

The secondary battery of this embodiment has the structure, the operation, and the effects similar to those of the first embodiment and can be similarly manufactured, except that the secondary battery of this embodiment has an anode 80 with the structure different from those of the anodes 22, 34, and 72 in the first embodiment. Therefore, descriptions of the elements thereof substantially identical with those of the first embodiment will be omitted.

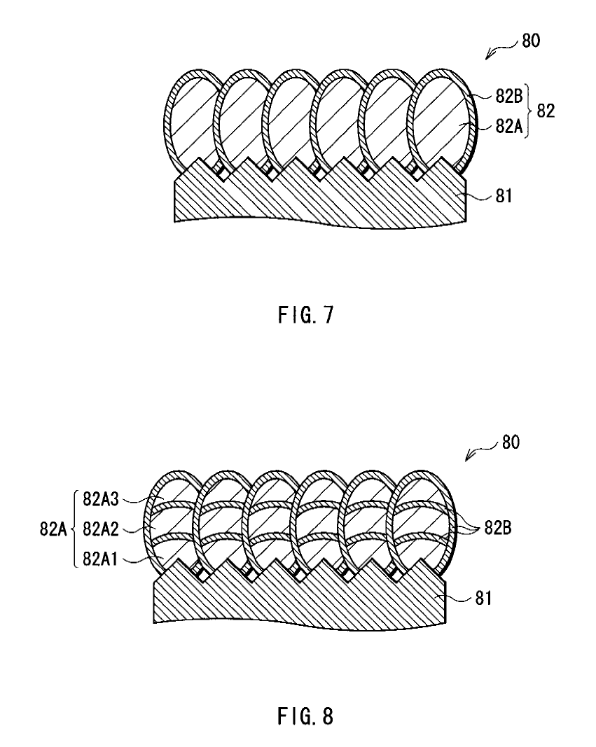

As shown in FIG. 7, the anode 80 has a structure in which an anode active material layer 82 is provided on an anode current collector 81. FIG. 7 is a cross sectional structure schematically showing a structure of an enlarged part of the anode 80. The anode active material layer 82 has a plurality of anode active material particles 82A made of an anode active material similar to that of the first embodiment. On the surface of the anode active material particle 82A, a compound film 82B having Si—O bond and Si—N bond is formed. It is enough that the compound film 82B covers at least part of the surface of the anode active material particle 82A, for example, covers the region contacting with the electrolytic solution in the surface of the anode active material particle 82A (that is, the region other than the region contacting with the anode current collector 81, the binder, or other anode active material particle 82A). However, to further secure the chemical stability of the anode 80, the compound film 82B desirably covers a wide range of the surface of the anode active material particle 82A as much as possible. In particular, as shown in FIG. 7, the compound film 82B desirably covers the entire surface of the anode active material particle 82A.

The anode active material particle 82A is formed by, for example, one of vapor-phase deposition method, liquid-phase deposition method, spraying method, and firing method, or two or more of these methods. In particular, it is preferable that the anode active material particle 82A is formed by using vapor-phase deposition method, since the anode current collector 81 and the anode active material particle 82A are easily alloyed at the interface thereof at least in part. Alloying may be made in such a way that the element of the anode current collector 81 is diffused in the anode active material particle 82A, or the element of the anode active material particle 82A is diffused in the anode current collector 81. Otherwise, alloying may be made in such a way that the element of the anode current collector 81 and silicon as the element of the anode active material particle 82A are diffused in each other. When such alloying is made as above, structural breakage of the anode active material particle 82A caused by expansion and shrinkage due to charge and discharge is prevented, and electric conductivity between the anode current collector 81 and the anode active material particle 82A is improved.

As vapor-phase deposition method, for example, physical deposition method or chemical deposition method can be cited. Specifically, vacuum evaporation method, sputtering method, ion plating method, laser ablation method, thermal CVD (Chemical Vapor Deposition) method, plasma CVD method, spraying method and the like can be cited. As liquid-phase deposition method, a known technique such as electrolytic plating and electroless plating can be used. Firing method is, for example, a method in which a particulate anode active material, a binder and the like are mixed and dispersed in a solvent, and then the anode current collector is coated with the mixture, and the resultant is heat-treated at a temperature higher than the melting point of the binder and the like. For firing method, a known technique such as atmosphere firing method, reactive firing method, and hot press firing method can be cited.

The anode active material particle 82A preferably has a multilayer structure formed by layering a plurality of layers 82A1 to 82A3 as shown in FIG. 8. In this case, the compound film 82B is desirably formed on at least part of the interface between each of the plurality of layers 82A1 to 82A3. When the anode active material particle 82A is formed into such a multilayer structure, film formation of the anode active material particle 82A can be divided into several steps. Therefore, for example, when evaporation method or the like accompanying high heat in film formation is used, time that the anode current collector 81 is exposed at high heat can be reduced compared to a case that the anode active material particle 82A is formed into a single layer structure by a single film forming step. In the result, damage to the anode current collector 81 can be decreased. Further, when the anode active material particle 82A is formed into the multilayer structure (FIG. 8), the cycle characteristics can be more improved than in the case of the single layer structure (FIG. 7). It is thought that the reason thereof is as follows. That is, when the anode active material particle 82A is formed into the multilayer structure, the internal stress in film formation can be more relaxed than in the case of the single layer structure. Accordingly, destruction of the anode active material particle 82A caused by expansion and shrinkage due to charge and discharge is prevented.

Further, when the anode active material particle 82A has the multilayer structure as shown in FIG. 8, to prevent expansion and shrinkage of the anode active material layer 82, it is preferable that each anode active material particle 82A has a first oxygen-containing layer (layer that has the lower oxygen content) and a second oxygen-containing layer that has the higher oxygen content than the oxygen content of the first oxygen-containing layer (layer that has the higher oxygen content). In this case, in particular, it is preferable that the first oxygen-containing layer and the second oxygen-containing layer are alternately and repeatedly layered. For example, it is preferable that the layers 82A1 and 82A3 are the first oxygen-containing layer and the layer 82A2 is the second oxygen-containing layer.

The anode active material particle 82A including the first oxygen-containing layer and the second oxygen-containing layer can be formed, for example, by intermittently introducing oxygen gas into a chamber when the anode active material is deposited by using vapor-phase deposition method. It is needless to say that when a desired oxygen content may not be obtained only by introducing oxygen gas, liquid (for example, moisture vapor or the like) may be introduced into the chamber.

As described above, in this embodiment, since the compound film 82B having Si—O bond and Si—N bond is formed on at least part of the surface of the anode active material particle 82A containing silicon provided on the anode current collector 81, the chemical stability of the anode 80 can be improved. Therefore, effects similar to those of the foregoing first embodiment can be obtained.

In particular, when the anode active material particle 82A has the multilayer structure in which the first oxygen-containing layer and the second oxygen-containing layer that respectively have the oxygen content different from each other are alternately and repeatedly layered, expansion and shrinkage of the anode active material layer 82 can be prevented.

### EXAMPLES

Next, specific examples of the invention will be described in detail.

### Examples 1-1 and 1-2

The square secondary batteries shown in FIGS. 5 and 6 (note, however, that the secondary battery includes the anode 80 shown in FIG. 7) were fabricated.

First, the cathode 71 was formed. Specifically, lithium carbonate (Li₂CO₃) and cobalt carbonate (CoCo₃) were mixed at a molar ratio of 0.5:1. After that, the resultant mixture was fired in the air at 900 deg C. for 5 hours, and thereby lithium cobalt complex oxide (LiCoO₂) was obtained. Subsequently, 91 parts by weight of the lithium cobalt complex oxide as a cathode active material, 6 parts by weight of graphite as an electrical conductor, 3 parts by weight of polyvinylidene fluoride as a binder were mixed to obtain a cathode mixture. After that, the cathode mixture was dispersed in N-methyl-2-pyrrolidone to obtain paste cathode mixture slurry. Finally, the both faces of the cathode current collector 71A made of a strip-shaped aluminum foil (being 12 μm thick) were uniformly coated with the obtained cathode mixture slurry, which was dried and compression-molded by a rolling press machine to form the cathode active material layer 71B. After that, the cathode lead 74 made of aluminum was attached to an end of the cathode current collector 71A by welding.

Next, the anode 80 was formed as follows. Specifically, the anode current collector 81 (surface roughness Ra: 0.4 μm) made of an electrolytic copper foil was prepared and placed in a chamber. After that, silicon was deposited on the both faces of the anode current collector 81 by electron beam evaporation method while introducing oxygen gas into the chamber. Thereby, the anode active material particle 82A being 6 μm thick was formed. As the evaporation source, silicon with the purity of 99% was used and the deposition rate was 100 nm/sec. Subsequently, the anode active material particle 82A provided on the anode current collector 81 was provided with polysilazane treatment in such a manner that the anode active material particle 82A provided on the anode current collector 81 was dipped in a solution in which perhydropolysilazane was dissolved in xylene at a concentration of 5 wt % for three minutes. The resultant was taken out, and then left in the air for 24 hours. In this stage, due to reaction between silicon composing the anode active material particle 82A and perhydropolysilazane, due to decomposition reaction of perhydropolysilazane itself or the like, Si—N bond was formed. In addition, due to reaction between part of moisture in the air and part of perhydropolysilazane, Si—O bond was formed. After that, the resultant was washed with dimethyl carbonate (DMC) and vacuum-dried. In the result, the anode 80 including the anode active material particle 82 covered with the compound film 82B having Si—O bond and Si—N bond was obtained. Further, the anode lead 75 made of nickel was welded to one end of the anode current collector 81.

When XPS measurement was performed for the obtained compound film 82B, peak of Si2p_{1/2}Si—N was observed at 103.7 eV, and peak of Si2p_{3/2}Si—N was observed at 103.1 eV. Thereby, existence of Si—N bond in the compound film 82B was confirmed. In this case, for correcting the energy axis of the spectrum, respective peaks of Si2p_{1/2}Si—O and Si2p_{3/2}Si—O were used. The compound film 82B includes both Si—O bond and Si—N bond. Thus, by analysis with the use of a commercially available software, the peaks of Si2p_{1/2}Si—O and Si2p_{3/2}Si—O were separated from the peaks of Si2p_{1/2}Si—N and Si2p_{3/2}Si—N. In the analysis of the waveform, the position of the main peak existing on the lowest bound energy side was set to the energy reference (99.5 eV).

Subsequently, the separator 73 made of a microporous polyethylene film being 16 μm thick was prepared. The cathode 71 and the anode 80 were layered with the separator 73 in between to form a lamination. After that, the lamination was spirally wound a plurality of times, and thereby the spirally wound electrode body 70 was formed. The obtained spirally wound electrode body 70 was formed into a flat shape. In Example 1-2, the compound film having Si—O bond and Si—N bond was also formed on the separator 73.

Next, the spirally wound electrode body 70 formed into the flat shape was contained inside the package can 61. After that, the insulating plate 62 was arranged on the spirally wound electrode body 70, the anode lead 75 was welded to the package can 61, the cathode lead 74 was welded to the lower end of the cathode pin 65, and the battery cover 63 was fixed to the open end of the package can 61 by laser welding. After that, an electrolytic solution was injected through the injection hole 69 into the package can 61. As the electrolytic solution, a solution in which LiPF₆ as an electrolyte salt was dissolved at a concentration of 1 mol/dm³ in a mixed solvent of 40 volume % of ethylene carbonate and 60 volume % of diethyl carbonate was used. Finally, the injection hole 69 was sealed with the sealing member 69A, and thereby the square secondary battery was obtained.

Further, as Comparative example 1-1 relative to Example 1-1 and Comparative example 1-2 relative to Example 1-2, secondary batteries were fabricated in the same manner as in Example 1-1 or Example 1-2, except that the compound film was not provided on the surface of the anode active material particle.

For the fabricated secondary batteries of Examples 1-1, 1-2 and Comparative examples 1-1, 1-2, charge and discharge were made under the environment of 45 deg C. by the following procedure. First, regarding charge, after constant current charge was made at the constant current density of 3 mA/cm² until the battery voltage reached 4.2 V, constant voltage charge was continuously made at the constant voltage of 4.2 V until the time from the charge start became 2.5 hours in total. Regarding discharge, constant current discharge was made at the constant current density of 5 mA/cm² until the battery voltage reached 2.5 V. The foregoing combination of charge and discharge was regarded as 1 cycle, and charge and discharge were made until the 100th cycle. The discharge capacity ratio at the 100th cycle to the discharge capacity at the first cycle, that is, (discharge capacity at the 100th cycle/discharge capacity at the first cycle)×100(%) was calculated as a discharge capacity retention ratio. The results are shown in Table 1.

TABLE 1
Anode active material particle: single layer structure

| | | | | | | Discharge |
|---|---|---|---|---|---|---|
| | | | Electrolytic solution | | | capacity |
| | Compound film | | | Content | Lithium | retention |
| | Anode | Separator | Material | (wt %) | salt | ratio (%) |
| Example 1-1 | Provided | Not | EC | 40 | LiPF₆ | 85 |
| | | provided | DEC | 60 | | |
| Example 1-2 | Provided | Provided | EC | 40 | LiPF₆ | 84 |
| | | | DEC | 60 | | |
| Comparative | Not | Not | EC | 40 | LiPF₆ | 81 |
| Example 1-1 | provided | provided | DEC | 60 | | |
| Comparative | Not | Provided | EC | 40 | LiPF₆ | 80 |
| Example 1-2 | provided | | DEC | 60 | | |

As shown in Table 1, both in Example 1-1 and Example 1-2, the discharge capacity retention ratio higher than that of Comparative example 1-1 and Comparative example 1-2 was shown. Therefore, it could be confirmed that the cycle characteristics were improved by covering the anode active material particle with the compound film having Si—O bond and Si—N bond. Meanwhile, based on comparison between Example 1-1 and Example 1-2 and comparison between Comparative example 1-1 and Comparative example 1-2, it was confirmed that if the compound film having Si—O bond and Si—N bond was formed on the separator, the cycle characteristics were not improved, or if anything, the cycle characteristics were slightly lowered. It is thought that the reason thereof was as follows. When the foregoing compound film was formed on the separator, there were little effect to prevent decomposition reaction of the electrolytic solution. In addition, when the compound film was formed on the separator, a decomposed matter of the silazane compound intruded into a void of the separator, the resistance of the separator was increased, and thus the cycle characteristics were adversely affected.

### Examples 2-1 to 2-4

In these examples, the square secondary batteries shown in FIGS. 5 and 6 (however, the anode 80 shown in FIG. 8 was included) were fabricated. Example 2-1 was obtained in the same manner as in Example 1-1, except that when the anode 80 was formed, the anode active material particle 82A having a three-layer structure was formed by sequentially evaporating the layers 82A1 to 82A3 respectively having the thickness of 2 μm. Examples 2-2 and 2-3 were obtained in the same manner as in Example 1-1, except that fluoroethylene carbonate (FEC) or difluoroethylene carbonate (DFEC) was added to the electrolytic solution at a given ratio respectively (refer to Table 2 below). Example 2-4 was obtained in the same manner as in example 2-3, except that as a lithium salt, a solution in which LiPF₆ and LiBF₄ were dissolved in a solvent at a concentration of 0.8 mol/dm³ and 0.2 mol/dm³, respectively was used. The cross section of the anode active material layer 82 was cut out by a microtome, and micro-site element analysis was performed by using an SEM (Scanning Electron Microscope) and an EDX (Energy Dispersive X-ray spectrometer). In the result, abundant nitrogen atoms and oxygen atoms were detected in each interface between each of the layers 82A1 to 82A3 as well. That is, it was confirmed that the compound film 82B was formed.

As Comparative example 2-1 relative to Example 2-1, a secondary battery was fabricated in the same manner as in Example 1-1, except that the compound film was not provided on the surface of the anode active material particle.

For the secondary batteries of Examples 2-1 to 2-4 and Comparative example 2-1, the discharge capacity retention ratio was measured in the same manner as in Examples 1-1, 1-2 and Comparative examples 1-1, 1-2. The results are shown in Table 2.

TABLE 2
Anode active material particle: multilayer structure

| | | | | | | Discharge |
|---|---|---|---|---|---|---|
| | Compound | Electrolytic solution | | | | capacity |
| | film | | Content | | | retention |
| | (anode) | Material | (wt %) | Lithium salt | | ratio (%) |
| Example 2-1 | Provided | EC | 40 | LiPF₆ | 1.0 M | 88 |
| | | DEC | 60 | | | |
| Example 2-2 | Provided | FEC | 10 | LiPF₆ | 1.0 M | 90 |
| | | EC | 30 | | | |
| | | DEC | 60 | | | |
| Example 2-3 | Provided | DFEC | 10 | LiPF₆ | 1.0 M | 92 |
| | | EC | 30 | | | |
| | | DEC | 60 | | | |
| Example 2-4 | Provided | DFEC | 10 | LiPF₆ | 0.8 M | 94 |
| | | EC | 30 | LiBF₄ | 0.2 M | |
| | | DEC | 60 | | | |
| Comparative | Not | EC | 40 | LiPF₆ | 1.0 M | 82 |
| Example 2-1 | provided | DEC | 60 | | | |

As shown in Table 2, in all Examples 2-1 to 2-4, the discharge capacity retention ratio higher than that of Comparative example 2-1 was shown. Therefore, it could be confirmed that the cycle characteristics were improved by covering the anode active material particle with the compound film having Si—O bond and Si—N bond, even when the anode active material particle had the multilayer structure. Further, based on comparison between Example 1-1 and Example 2-1, it was confirmed that when the anode active material particle had the multilayer structure, the cycle characteristics were improved.

### Examples 3-1 to 3-5

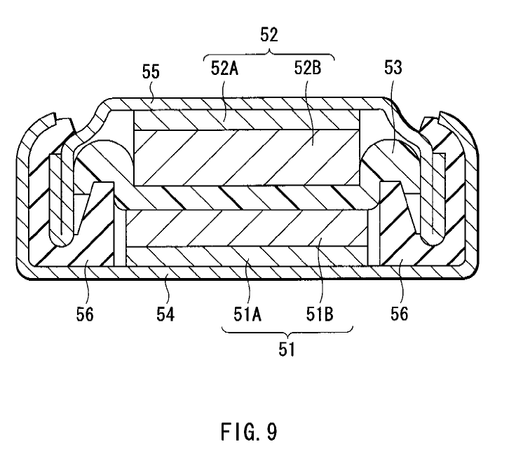

In these examples, the coin type secondary batteries shown in FIG. 9 were fabricated. In the secondary battery, a cathode 51 and an anode 52 were layered with a separator 53 in between to obtain a lamination, and the resultant lamination was sandwiched between a package can 54 and a package cup 55 and was caulked with a gasket 56. In the cathode 51, a cathode current collector 51A was provided with a cathode active material layer 51B. In the anode 52, an anode current collector 52A was provided with an anode active material layer 52B.

First, the cathode current collector 51A made of an aluminum foil being 12 μm thick was coated with cathode mixture slurry formed in the same manner as in Example 1-1. The resultant was dried and compression-molded to form the cathode active material layer 51B. After that, the resultant was punched out into a pellet being 15.5 mm in diameter to form the cathode 51.

Next, the anode 52 was formed as follows. First, a plurality of anode active material particles were formed in the same manner as in Example 1-1, except that silicon or a mixture of silicon and iron was deposited on the anode current collector 52A made of a copper foil being 20 μm thick by electron beam evaporation method. The iron content in the anode active material particle was changed as shown in the column of “Before treatment” of “Content (atomic %)” of “Metal (anode active material layer)” of Table 3 (below). After that, polysylazane treatment similar to that of Example 1-1 was performed and thereby the compound film having Si—O bond and Si—N bond was formed on the surface of the anode active material particle and the anode active material layer 52B was obtained.

Subsequently, the formed cathode 51 and the formed anode 52 were layered with the separator 53 made of a micro porous polypropylene film in between to obtain a lamination, and the lamination was placed on the package can 54. An electrolytic solution was injected therein from above, the package cup 55 was laid thereon, and the package can 54 and the package cup 55 were caulked and thereby hermetically sealed. For the electrolytic solution, a solution obtained by dissolving LiPF₆ as an electrolyte salt in a mixed solvent of 40 volume % of ethylene carbonate and 60 volume % of diethyl carbonate at a concentration of 1 mol/dm³ was used.

As Comparative examples 3-1 to 3-5, secondary batteries were fabricated in the same manner as in the examples, except that the compound film was not formed on the surface of the anode active material particle. As Comparative examples 3-6 to 3-10, secondary batteries were fabricated in the same manner as in the examples, except that a compound film made of silicon oxide (SiO₂) was formed on the surface of the anode active material particle by using wet SiO₂ treatment. The wet SiO₂ treatment means a surface treatment using fluosilicate (H₂SiF₆). Specifically, H₂SiF₆ saturated solution was prepared. The anode active material particle provided on the anode current collector 51A was dipped in the H₂SiF₆ saturated solution, to which boric acid (B(OH)₃) was added at a ratio of 0.027 mol/dm³ per minute for 3 hours, and thereby SiO₂ was precipitated on the surface of the anode active material. After SiO₂ was precipitated on the surface of the anode active material, the resultant was washed with water and dried, and thereby the compound film made of SiO₂ formed on the surface of the anode active material particle was obtained.

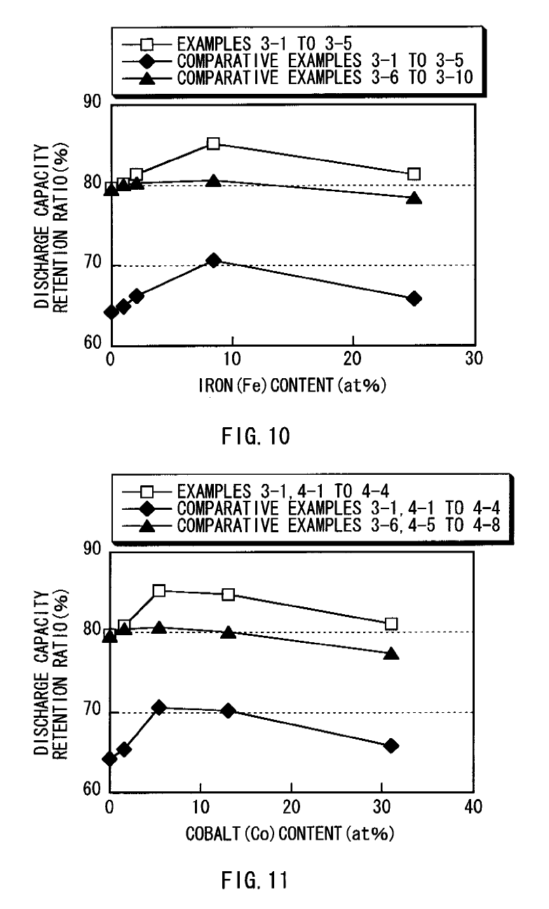

For the fabricated secondary batteries of the examples and Comparative examples 3-1 and 3-10, a charge and discharge test was performed at the ambient temperature. The evaluation conditions were as follows. First, after charge was made at the constant current density of 3 mA/cm² until the battery voltage reached 4.2 V, charge was further made at the constant voltage of 4.2 V until the battery density reached 0.2 mA/cm². After that, discharge was made at the constant current density of 3 mA/cm² until the battery voltage reached 2.5 V. The results of the charge and discharge test are shown in Table 3 and FIG. 10.

TABLE 3

| | | | Metal (anode active | | | |
|---|---|---|---|---|---|---|
| | | | material layer) | | | Discharge |
| | Compound | | | Content (atomic %) | | capacity |
| | film | Surface | | Before | After | retention |
| | (anode) | treatment | Type | treatment | treatment | ratio (%) |
| Example 3-1 | Provided | Polysilazane | — | — | — | 79.7 |
| | | treatment | | | | |
| Example 3-2 | Provided | Polysilazane | Fe | 1.0 | 1.0 | 80.2 |
| | | treatment | | | | |
| Example 3-3 | Provided | Polysilazane | Fe | 2.1 | 2.1 | 81.4 |
| | | treatment | | | | |
| Example 3-4 | Provided | Polysilazane | Fe | 8.4 | 8.4 | 85.2 |
| | | treatment | | | | |
| Example 3-5 | Provided | Polysilazane | Fe | 25.0 | 25.0 | 81.3 |
| | | treatment | | | | |
| Comparative | Not | N/A | — | — | | 64.2 |
| Example 3-1 | provided | | | | | |
| Comparative | Not | N/A | Fe | 1.0 | | 64.9 |
| Example 3-2 | provided | | | | | |
| Comparative | Not | N/A | Fe | 2.1 | | 66.2 |
| Example 3-3 | provided | | | | | |
| Comparative | Not | N/A | Fe | 8.4 | | 70.6 |
| Example 3-4 | provided | | | | | |
| Comparative | Not | N/A | Fe | 25.0 | | 65.8 |
| Example 3-5 | provided | | | | | |
| Comparative | Provided | Wet SiO₂ | — | — | — | 79.5 |
| Example 3-6 | | treatment | | | | |
| Comparative | Provided | Wet SiO₂ | Fe | 1.0 | 0.9 | 80.1 |
| Example 3-7 | | treatment | | | | |
| Comparative | Provided | Wet SiO₂ | Fe | 2.1 | 1.8 | 80.3 |
| Example 3-8 | | treatment | | | | |
| Comparative | Provided | Wet SiO₂ | Fe | 8.4 | 7.6 | 80.6 |
| Example 3-9 | | treatment | | | | |
| Comparative | Provided | Wet SiO₂ | Fe | 25.0 | 22.0 | 78.4 |
| Example 3-10 | | treatment | | | | |

In Table 3, the iron content at the time of forming the anode active material particle (before surface treatment) is filled in the column of “Before treatment” of “Content (atomic %)” of “Metal (anode active material layer),” and the iron content after forming the compound film (after surface treatment) is filled in the column of “After treatment.” However, since the surface treatment of the anode active material particle was not performed in Comparative examples 3-1 to 3-5, the iron content at the time of forming the anode active material particle (before surface treatment) is filled in as a representative in Comparative examples 3-1 to 3-5. FIG. 10 corresponds to Table 3, and shows change of the discharge capacity retention ratio to the iron content. In FIG. 10, the horizontal axis represents an iron content [at %] after surface treatment, and the vertical axis represents a discharge capacity retention ratio [%].

As shown in Table 3 and FIG. 10, in these examples, the following tendency was confirmed. That is, if the iron content was in the range from 0 to 8.4 atomic %, as the iron content was increased, the discharge capacity retention ratio was increased accordingly. If the iron content was over 8.4 atomic %, as the iron content was increased, the discharge capacity retention ratio was gradually decreased. In Comparative examples 3-1 to 3-5 in which the surface treatment was not performed, similar tendency was observed. However, when comparison was made between the examples and Comparative examples 3-1 to 3-5, for the discharge capacity retention ratio corresponding to the same iron content, higher numerical values were obtained in the examples. Meanwhile, in Comparative examples 3-6 to 3-10 in which wet SiO₂ treatment was performed, the iron content after the surface treatment was lower than that before the surface treatment, and adding iron did not result in large improvement of the discharge capacity retention ratio. In particular, when comparison was made between Examples 3-4 and 3-5 and Comparative examples 3-9 and 3-10 that respectively have the identical iron content before surface treatment, there was large differences in the discharge capacity retention ratio. Further, as evidenced by the graph show in FIG. 10, when comparison was made between these examples and Comparative examples 3-6 to 3-10 based on the iron content after surface treatment, higher discharge capacity retention ratio was shown in these examples over the entire range. The iron content was decreased after surface treatment in Comparative examples 3-6 to 3-10. The reason thereof was possibly that iron was eluted in the H₂SiF₆ saturated solution. In Comparative examples 3-6 to 3-10, the discharge capacity retention ratio was not improved equally to in Examples 3-2 to 3-5 in which polysilazane treatment was performed. Some of the reasons thereof may be as follows. First, structural change of the anode active material itself due to iron eluted from the anode active material may affect the result. Secondary, side reaction such as interaction between the anode active material made of silicon and iron and Si—N bond may affect the result. Further, when comparison was made between Example 3-1 and Comparative example 3-6, Example 3-1 showed the slightly higher discharge capacity retention ratio. Such a result may be caused by existence of Si—N bond in the compound film.

Though not shown in Table 3, it was confirmed that even in the case that the compound film was formed by polysilazane treatment, if the iron content in the anode active material particle was over 40 atomic %, the discharge capacity retention ratio was more deteriorated than that of Example 3-1 in which iron was not added.

### Examples 4-1 to 4-4

In these examples, the coin type secondary battery shown in FIG. 9 was fabricated in the same manner as in Examples 3-2 to 3-5, except that instead of iron, cobalt was contained in the anode active material. The cobalt content in the anode active material particle was changed as shown in the column of “Before treatment” of “Content (atomic %)” of “Metal (anode active material layer)” of Table 4 (below).

As Comparative examples 4-1 to 4-4, secondary batteries were fabricated in the same manner as in the examples, except that the compound film was not formed on the surface of the anode active material particle. As Comparative examples 4-5 to 4-8, secondary batteries were fabricated in the same manner as in the examples, except that a compound film made of SiO₂ was formed on the surface of the anode active material particle by using wet SiO₂ treatment similar to that of Comparative examples 3-6 to 3-10.

For the fabricated secondary batteries of the examples and Comparative examples 4-1 to 4-8, a charge and discharge test was performed at the ambient temperature. The evaluation conditions were similar to those of Examples 3-1 to 3-5. The results of the charge and discharge test are shown in Table 4 and FIG. 11 together with the results of Example 3-1, Comparative examples 3-1 and 3-6.

TABLE 4

| | | | Metal (anode active | | | |
|---|---|---|---|---|---|---|
| | | | material layer) | | | Discharge |
| | Compound | | | Content (atomic %) | | capacity |
| | film | Surface | | Before | After | retention |
| | (anode) | treatment | Type | treatment | treatment | ratio (%) |
| Example 3-1 | Provided | Polysilazane | — | — | — | 79.7 |
| | | treatment | | | | |
| Example 4-1 | Provided | Polysilazane | Co | 1.6 | 1.6 | 80.8 |
| | | treatment | | | | |
| Example 4-2 | Provided | Polysilazane | Co | 5.4 | 5.4 | 85.2 |
| | | treatment | | | | |
| Example 4-3 | Provided | Polysilazane | Co | 13 | 13 | 84.7 |
| | | treatment | | | | |
| Example 4-4 | Provided | Polysilazane | Co | 31 | 31 | 81.0 |
| | | treatment | | | | |
| Comparative | Not | N/A | — | — | | 64.2 |
| Example 3-1 | provided | | | | | |
| Comparative | Not | N/A | Co | 1.6 | | 65.4 |
| Example 4-1 | provided | | | | | |
| Comparative | Not | N/A | Co | 5.4 | | 70.6 |
| Example 4-2 | provided | | | | | |
| Comparative | Not | N/A | Co | 13 | | 70.2 |
| Example 4-3 | provided | | | | | |
| Comparative | Not | N/A | Co | 31 | | 65.8 |
| Example 4-4 | provided | | | | | |
| Comparative | Provided | Wet SiO₂ | — | — | — | 79.5 |
| Example 3-6 | | treatment | | | | |
| Comparative | Provided | Wet SiO₂ | Co | 1.6 | 1.4 | 80.4 |
| Example 4-5 | | treatment | | | | |
| Comparative | Provided | Wet SiO₂ | Co | 5.4 | 4.7 | 80.6 |
| Example 4-6 | | treatment | | | | |
| Comparative | Provided | Wet SiO₂ | Co | 13 | 12 | 80.0 |
| Example 4-7 | | treatment | | | | |
| Comparative | Provided | Wet SiO₂ | Co | 31 | 27 | 77.3 |
| Example 4-8 | | treatment | | | | |

In Table 4, the cobalt content at the time of forming the anode active material particle (before surface treatment) is filled in the column of “Before treatment” of “Content (atomic %)” of “Metal (anode active material layer),” and the cobalt content after forming the compound film (after surface treatment) is filled in the column of “After treatment.” However, since the surface treatment of the anode active material particle was not performed in Comparative examples 4-1 to 4-4, the cobalt content at the time of forming the anode active material particle (before surface treatment) is filled in as a representative in Comparative examples 4-1 to 4-4. FIG. 11 corresponds to Table 4, and shows change of the discharge capacity retention ratio to the cobalt content. In FIG. 11, the horizontal axis represents a cobalt content [at %] after surface treatment, and the vertical axis represents a discharge capacity retention ratio [%].

As shown in Table 4 and FIG. 11, in these examples, the following tendency was confirmed. That is, if the cobalt content was in the range from 0 to 5.4 atomic %, as the cobalt content was increased, the discharge capacity retention ratio was increased accordingly. If the cobalt content was over 5.4 atomic %, as the cobalt content was increased, the discharge capacity retention ratio was gradually decreased. In Comparative examples 3-1 and 4-1 to 4-4 in which the surface treatment was not performed, similar tendency was observed. However, when comparison was made between the examples and Comparative examples 3-1 and 4-1 to 4-4 for the discharge capacity retention ratio corresponding to the same cobalt content, higher numerical values were obtained in the examples. Meanwhile, in Comparative examples 3-6 and 4-5 to 4-8 in which wet SiO₂ treatment was performed, the cobalt content after surface treatment was lower than that before surface treatment, and adding cobalt did not result in large improvement of the discharge capacity retention ratio. In particular, when comparison was made between Examples 4-2 to 4-4 and Comparative examples 4-6 to 4-8 that respectively have the identical cobalt content before surface treatment, there were large differences in the discharge capacity retention ratio. Further, as evidenced by the graph shown in FIG. 11, when comparison was made between these examples and Comparative examples 4-5 to 4-8 based on the cobalt content after surface treatment, higher discharge capacity retention ratios were shown in these examples over the entire range. The cobalt content was decreased after surface treatment in Comparative examples 4-5 to 4-8. The reason thereof was possibly that cobalt was eluted in the H₂SiF₆ saturated solution. In Comparative examples 4-5 to 4-8, the discharge capacity retention ratio was not improved equally to in Examples 4-1 to 4-4 in which polysilazane treatment was performed. Some of the reasons thereof may be as follows. First, structural change of the anode active material itself due to cobalt eluted from the anode active material may affect the result. Secondary, side reaction such as interaction between the anode active material made of silicon and cobalt and Si—N bond may affect the result.

Though not shown in Table 4, it was confirmed that even in the case that the compound film was formed by polysilazane treatment, if the cobalt content in the anode active material particle was over 40 atomic %, the discharge capacity retention ratio was more deteriorated than that of Example 3-1 in which cobalt was not added.

Further, though the description has been given of only the cases in which iron or cobalt was added to the anode active material in the foregoing examples, it was also confirmed that in addition to iron and cobalt, when nickel, germanium, tin, arsenic, zinc, copper, titanium, chromium, magnesium, calcium, aluminum, or silver was added to the anode active material as a second element at a ratio, for example, from 1.0 atomic % to 40 atomic %, similar tendency was observed.

The invention has been described with reference to the embodiments and the examples. However, the invention is not limited to the foregoing embodiments and the foregoing examples, and various modifications may be made. For example, in the foregoing embodiments and the foregoing examples, the descriptions have been given with specific examples of the cylindrical secondary battery, the laminated film secondary battery, and the square secondary battery that respectively have the spirally wound battery element (electrode body). However, the invention can be similarly applied to a secondary battery in which the package member has other shape such as a button type secondary battery and a coin type secondary battery, or a secondary battery having a battery element (electrode body) with other structure such as a lamination structure. Further, the invention can be applied not only to the secondary batteries but also to primary batteries.

Further, in the foregoing embodiments and the foregoing examples, the descriptions have been given of the case using lithium as an electrode reactant. However, the invention can be applied to the case using other element of Group 1 in the long period periodic table such as sodium (Na) and potassium (K), an element of Group 2 in the long period periodic table such as magnesium and calcium (Ca), other light metal such as aluminum, or an alloy of lithium or the foregoing elements as well, and similar effects can be thereby obtained. At this time, an anode active material capable of inserting and extracting an electrode reactant, a cathode active material, a solvent and the like are selected according to the electrode reactant.

It should be understood by those skilled in the art that various modifications, combinations, sub-combinations and alternations may occur depending on design requirements and other factors insofar as they are within the scope of the appended claims or the equivalents thereof.

What is claimed is:

1. An anode being provided with an anode active material layer on an anode current collector, wherein
the anode active material layer contains silicon (Si) as an anode active material and includes a compound film having Si—O bond and Si—N bond on at least part of the surface of the anode active material layer.

2. An anode being provided with an anode active material layer on an anode current collector, wherein
the anode active material layer contains an anode active material particle made of an anode active material containing silicon (Si) and includes a compound film having Si—O bond and Si—N bond on at least part of the surface of the anode active material particle.

3. The anode according to claim 2, wherein the anode active material particle has a multilayer structure in which a plurality of layers are layered, and the compound film is also provided in at least part of an interface between the respective layers.

4. The anode according to claim 2, wherein the anode active material contains at least one of metalloids other than silicon and metals.

5. The anode according to claim 4, wherein the metal is iron (Fe) or cobalt (Co).

6. The anode according to claim 4, wherein the metal is contained at a ratio from 1.0 atomic % to 40 atomic % in the anode active material.

7. A method of manufacturing an anode comprising steps of:
providing an anode active material layer having an anode active material containing silicon (Si) on an anode current collector; and
forming a compound film having Si—O bond and Si—N bond on at least part of the surface of the anode active material layer by liquid-phase deposition method.

8. A method of manufacturing an anode comprising steps of:
providing an anode active material layer containing an anode active material particle made of an anode active material containing silicon (Si) on an anode current collector; and
forming a compound film having Si—O bond and Si—N bond on at least part of the surface of the anode active material particle by liquid-phase deposition method.

9. The method of manufacturing an anode according to claim 8, wherein after forming the anode active material particle having a plurality of layers by vapor-phase deposition method, the compound film is also formed in at least part of an interface between each of the plurality of layers.

10. The method of manufacturing an anode according to claim 8, wherein the compound film is formed by reacting the anode active material particle to a solution containing a silazane-based compound.

11. The method of manufacturing an anode according to claim 8, wherein the anode active material is formed to contain at least one of metalloids other than silicon and metals together with silicon.

12. The method of manufacturing an anode according to claim 11, wherein the metal is iron (Fe) or cobalt (Co).

13. The method of manufacturing an anode according to claim 11, wherein the metal is contained at a ratio from 1.0 atomic % to 40 atomic % in the anode active material.

14. A battery comprising:
a cathode;
an anode; and
an electrolyte,
wherein the anode has an anode current collector and an anode active material layer provided on the anode current collector, and
the anode active material layer contains silicon (Si) as an anode active material and includes a compound film having Si—O bond and Si—N bond on at least part of the surface of the anode active material layer.

15. A battery comprising:
a cathode;
an anode; and
an electrolyte,
wherein the anode has an anode current collector and an anode active material layer provided on the anode current collector, and
the anode active material layer contains an anode active material particle made of an anode active material containing silicon (Si) and includes a compound film having Si—O bond and Si—N bond on at least part of the surface of the anode active material particle.

16. The battery according to claim 15, wherein the anode active material particle has a multilayer structure in which a plurality of layers are layered, and the compound film is also provided in at least part of an interface between the respective layers.

17. The battery according to claim 15, wherein the anode active material contains at least one of metalloids other than silicon and metals.

18. The battery according to claim 17, wherein the metal is iron (Fe) or cobalt (Co).

19. The battery according to claim 17, wherein the metal is contained at a ratio from 1.0 atomic % to 40 atomic % in the anode active material.

20. The battery according to claim 17, wherein the electrolyte has a solvent containing at least one of a chain ester carbonate and a cyclic ester carbonate.

21. The battery according to claim 20, wherein the chain ester carbonate includes at least one of fluoromethylmethyl carbonate, bis(fluoromethyl) carbonate, and difuloromethylmethyl carbonate, and
the cyclic ester carbonate includes at least one of 4-fluoro-1,3-dioxolane-2-one and 4,5-difluoro-1,3-dioxolane-2-one.

22. The battery according to claim 17, wherein the electrolyte contains an electrolyte salt having boron (B) and fluorine (F).
